(19) United States
(12) Patent Application Publication
(10) Pub. No.: US 2013/0167108 A1
(43) Pub. Date: Jun. 27, 2013

(54) PROMOTION AND PACKAGE BUILD TOOL FOR CONFIGURABLE NETWORK COMPUTING SYSTEMS

(71) Applicants: Neeraj Kumar Shukla, Pune (IN); Sharad Bansal, Pune (IN)

(72) Inventors: Neeraj Kumar Shukla, Pune (IN); Sharad Bansal, Pune (IN)

(73) Assignee: INFOSYS LIMITED, Bangalore (IN)

(21) Appl. No.: 13/418,427

(22) Filed: Mar. 13, 2012

(30) Foreign Application Priority Data
Dec. 27, 2011 (IN) 4600/CHE/2011

(51) Int. Cl. G06F 9/44

(52) U.S. Cl. 717/101

(57) ABSTRACT

Computer-implemented systems, methods, and computer-readable media for project promotion, package assembly, and build processing in a Configurable Network Computing architecture comprising: receiving a request for a package build from a user; storing, by at least one of the one or more computing devices, the received request for the package build in a dataset; transmitting a request for promotion of the package build in response to storing the received request for the package build; receiving approval of the request for promotion; and initiating a promotion and build process.

### RELATED APPLICATION DATA

This application claims priority to Indian Patent Application No. 4600/CHE/2011, filed Dec. 27, 2011, which is hereby incorporated by reference in its entirety.

### BACKGROUND

Configurable Network Computing (“CNC”) is JD Edwards's (“JDE”) client-server proprietary architecture and methodology that implements its highly-scalable, enterprise-wide business solution software that can run on a variety of hardware, operating systems, and platforms. Project promotion, package assembly, package building, and deployment are crucial and time consuming CNC activities. The process of progressing from receiving a request for a package build to ultimately launching a build in a production environment includes several manual steps, each of which creates both inefficiencies and potential for human error. Package build requests are often received from users, developers, managers, or any other requesters via one or more emails or directly through a third-party user interface. For a single package build there may be several emails or submissions received through a third-party interface. In a manual information gathering process package build requests or related information may get missed as a user manually collates the requests. Once received and collated, package build requests are then manually stored into a JDE table.

Even once package build requests are received and stored, a CNC administrator must manually receive requests for promoting the package builds from a development or prototype environment into a production environment. The CNC administrator generally seeks the approval of a manager and, upon receiving approval, performs promotion or demotion of the request manually. The CNC administrator then assembles an update package build by selecting individual objects and defines the build for the package manually. Finally, once such onerous steps are complete, the CNC administrator can launch the build and a JDE compiler can compile the package build. The compiled package build may then be launched in the production environment.

In addition to the above mentioned steps relating to the lifecycle of a package build being cumbersome and error prone, in current systems there is a lack of liability for the steps of the lifecycle. JDE provides no mechanisms for coding and tracking package builds. Instead, separate mechanisms are involved in every step and related code must be passed between mechanisms or systems for each step. Additionally, by performing the steps of the lifecycle in bits and pieces, current systems are not streamlined.

Improved promotion and package build tools for CNC systems are desired.

### BRIEF DESCRIPTION OF THE DRAWINGS

FIG. 1 shows an exemplary process flow for embodiments to streamline the lifecycle of update package builds.

FIGS. 2A and 2B show an exemplary user interface for a developer to input a project name, source environment, and target environment.

FIG. 3 shows an exemplary user interface displaying both a promotion request and a demotion request.

FIG. 4 shows an example user interface display of production package build requests awaiting manager approval.

FIG. 5 shows an exemplary user interface configured to allow a single administrator to perform promotion, demotion, or promotion and build of one or more projects.

FIG. 6 shows a user interface of an exemplary software tool (e.g., a workbench) that lets a user view the status of plural Object Management Workbench (“OMW”) projects (e.g., update packages).

FIG. 7 shows an exemplary Promotion/Demotion Report.

FIG. 8 shows an exemplary computing device useful for performing processes disclosed herein.

While systems and methods are described herein by way of example and embodiments, those skilled in the art recognize that systems and methods for project promotion, package assembly, and build processing are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

### DETAILED DESCRIPTION

Disclosed embodiments provide systems, computer-implemented methods, and computer-readable media for collecting package build requests, performing automated promotion of packages, and assembling, building, and launching the packages. Thus, embodiments provide a streamlined solution in comparison to prior art systems. Additionally, embodiments provide liability throughout the lifecycle of a package build and promotion process.

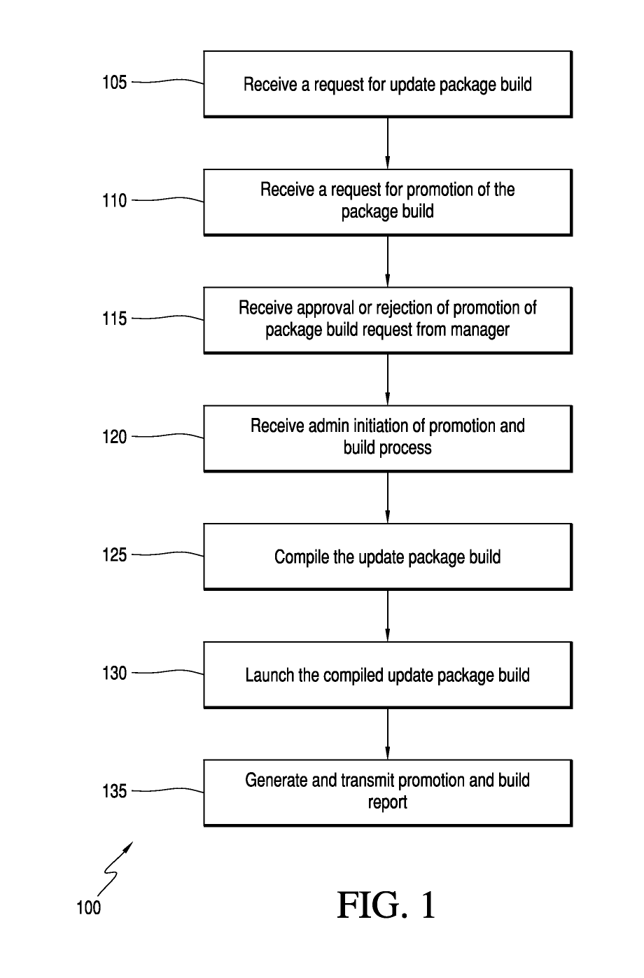

FIG. 1 illustrates an exemplary process flow 100 for embodiments to streamline the lifecycle of update package builds. At step 105, embodiments may receive a request for an update package build and populate the request into a dataset, such as a custom JDE table. To receive update package build requests, embodiments may provide a client user interface in which the user (e.g., a developer) can enter requirements for the update package build or code for the build. The user interface may, for example, be provided via an application running on a client computing device or may be provided through a browser. Independent of how the user interface is provided to a user, the update package build request entered through the user interface may be received by a server computing device. The server computing device may then store the update package build request in a dataset, such as a custom JDE table. Of course, in other embodiments the server computing device may receive the request for an update package build in other fashions. For example, an email account may be setup to allow developers to email requests directly to the system. Alternatively, a CNC administrator may manually enter requests for update package builds.

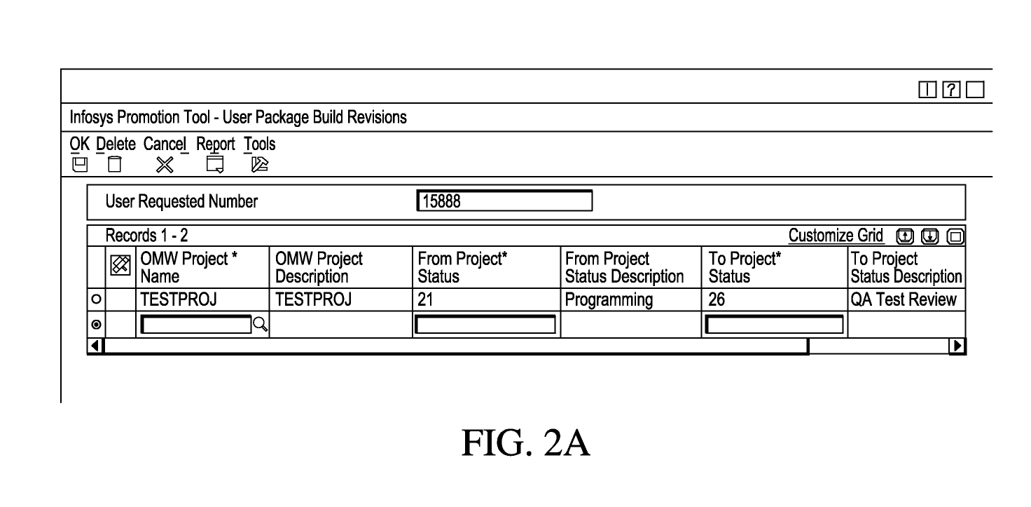

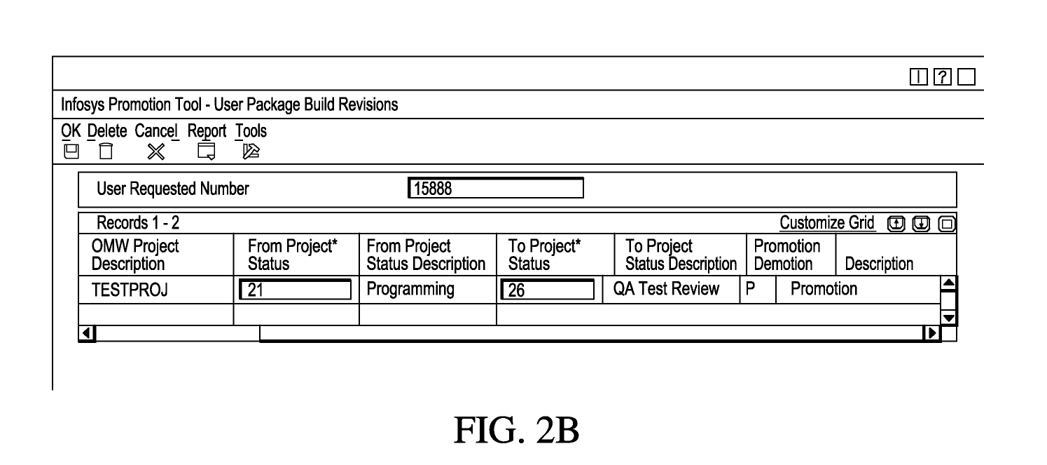

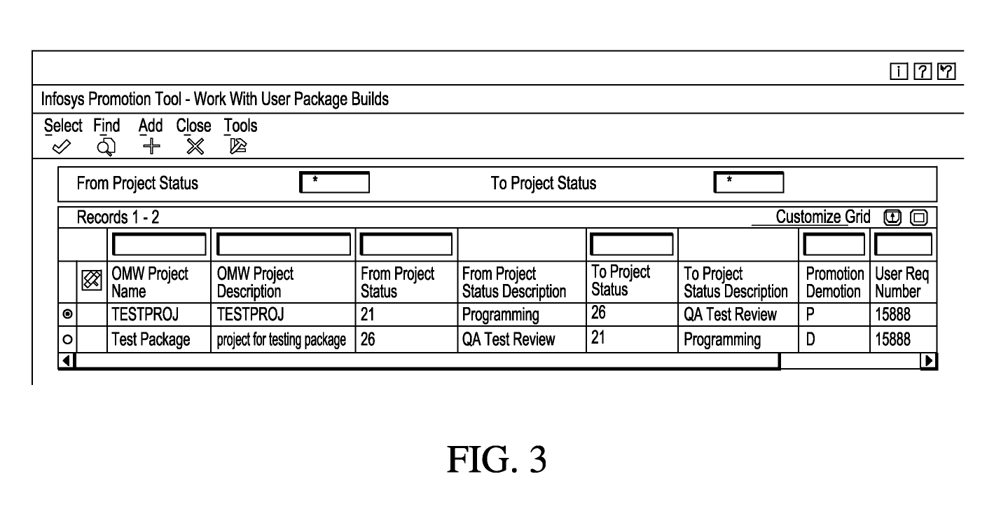

At step 110, once the update package build request has been stored in the dataset, the system may be configured to receive a request for promotion of the update package build. The request for promotion may be received from a developer and may include information about the project name (i.e., update package build name) and the source and target environments where the promotion or demotion needs to be done. Promotion means that the developer is requesting a code promotion as well as code build and deployment. Demotion means that the developer needs to rework on the project due to failed testing or due to an enhancement request. FIGS. 2A and 2B show an exemplary user interface for a developer to input a project name, source environment (indicated in the figures by a “From Project Status” numeral), and target environment (indicated in the figures by a “To Project Status” numeral). FIGS. 2A and 2B show multiple views of the same interface as indicated by the horizontal scroll bar positions. FIG. 3 shows an exemplary user interface displaying both a promotion request (indicated by the ‘P’ in the “Promotion/Demotion” column) and a demotion request (indicated by a ‘D’ in the “Promotion/Demotion” column).

In this step, a user interface screen may allow a user to select an update package build for promotion (indicated by “OMW Project Name” in FIGS. 2A and 2B) and select an environment for the update package build to be promoted to. For example, a user may select that an update package be promoted from a development environment (DEV) to a prototype environment (PY) or from a prototype environment (PY) to a production environment (PROD). Embodiments may employ rules relating to how an update package may be promoted, for example barring an update package from being promoted directly from a development (DEV) environment to a production environment (PROD). Some embodiments may also allow a user to request demotion of an update package build, for example to back an update package out of a prototype environment (PY) and back to a development environment (DEV). The server computing device may then receive the request for promotion of the update package build entered by the user.

Embodiments may include a custom application in JDE to take requests for promotion, demotion, and package build or any combination of these and store the information in a segregated manner in a database. The database may include a custom JDE table to store custom data for requests for promotion and information about further processing the request.

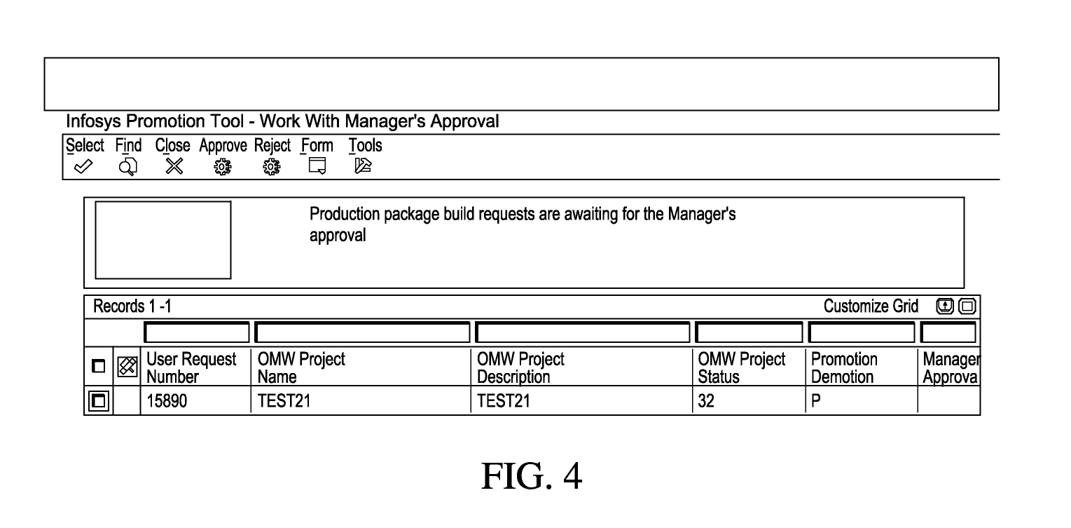

Once a request for promotion (or demotion) of an update package build is received, a user interface may be presented to a manager for approval of the request. FIG. 4 shows an example user interface display of production package build requests awaiting manager approval. The user interface may identify the update package (“OMW Project Name”), indicate the environments that the requester desires to promote the update package from and to (e.g., from a prototype environment (PY) to a production environment (PROD)), and any additional details relating to the requested promotion. Alternatively, the user interface may indicate demotion. The user interface may also include information relating to what testing has been done related to the requested promotion. Utilizing the user interface, the manager may approve or reject the requested promotion or demotion. At step 115, the server computing device may receive the approval or rejection of the requested promotion of an update package build from the manager.

Of course, in some embodiments step 115 may be automated. For example, embodiments may have a set of required criteria for an update package build to be promoted in accordance with a promotion request received in step 110. In such embodiments, automated systems may be utilized to determine whether the update package build satisfies the requisite criteria and, if so, the update package build may be automatically promoted. In other embodiments, if the request for promotion of an update package build received in step 110 is received from a user having requisite credentials (e.g., the request was initially received from a manager having rights associated with their account that allows them to promote into a given environment), step 115 may simply receive approval by virtue of the user's credentials (e.g., transmitted as metadata with the request).

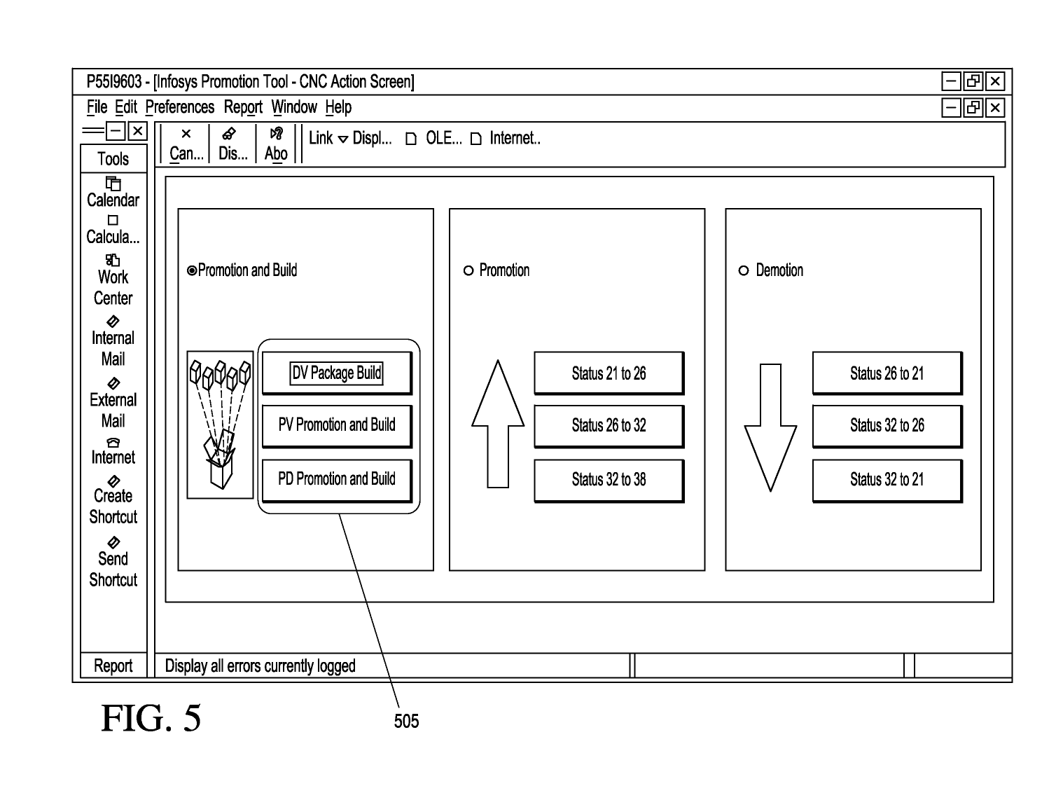

Once an update package build has been approved for promotion, at step 120 initiation from an administrator may be required to build the update package for the environment it is being promoted to. In some embodiments, a user interface screen may be presented to the CNC administrator and the administrator may manually initiate the promotion and build process. FIG. 5 shows an exemplary user interface configured to allow a single administrator to perform promotion, demotion, or promotion and build of one or more projects. As shown by buttons 505, an administrator may choose to build a package into a development environment, promote a package from a development environment and build the package into a prototype environment, or promote a package from a prototype environment and build the package into a production environment. In other embodiments, a CNC administrator may setup an automated initiation process. For example, on a computing device running Microsoft Windows, a scheduler may be set to automatically initiate the promotion and build process for package builds that have been approved for promotion to an environment at predetermined times.

At step 125, a computing device may compile the update package build to assemble an executable file. The compiler may be a tool within the CNC or JDE system (e.g., a C compiler tool). Once the code is compiled, at step 130 a computing device may launch the compiled update package build into the environment it was approved for promotion to (e.g., launch an update into the production environment). The launch may deploy the package on server and client machines. At this point, the lifecycle of the update package build is complete and the update is deployed.

Embodiments may perform promotion, assembly, and launch with one or more custom JDE Universal Batch Engine (“UBE”) report. Embodiments may include a customer JDE UBE to create a batch for promotion as per the request raised through the process flow and to call a standard UBE to perform the promotion. Embodiments may also include a custom JDE UBE for assembling and launching the build by calling a standard UBE for the same.

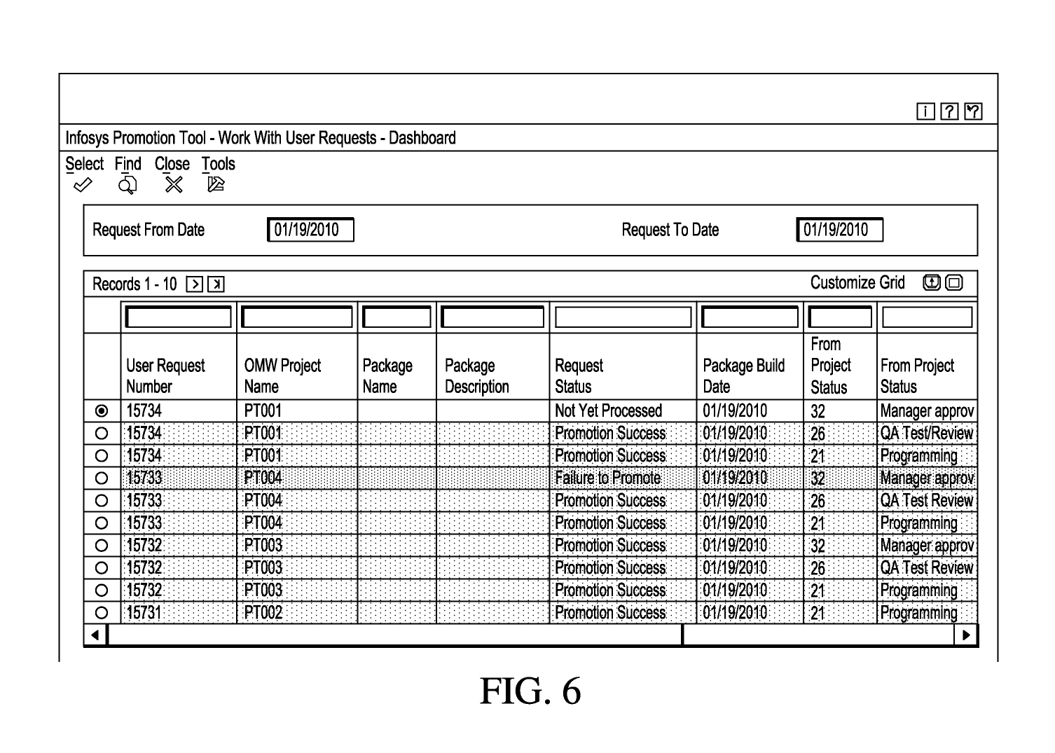

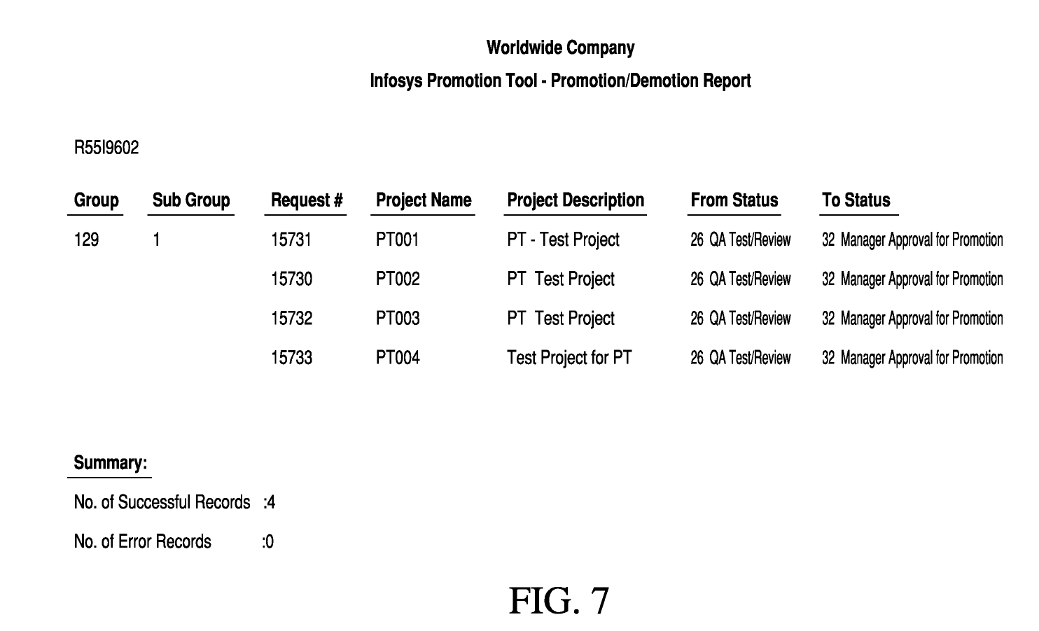

At an optional step 135, a computing system may generate and transmit one or more promotion and build reports. For example, FIG. 6 illustrates a user interface of an exemplary software tool (e.g., a workbench) that lets a user view the status of plural Object Management Workbench (“OMW”) projects (e.g., update packages). Such a tool may provide a user with various user interface controls for selecting and sorting projects to view by their request date, request name, request number, status, or other criteria. Of course, in alternative embodiments traditional reports may be provided rather than software tools. FIG. 7 illustrates an exemplary Promotion/Demotion Report. As shown in the report, each request has transitioned from status “26—QA Test Review” where quality testing was being performed on the project to “32 Manager approval for Promotion” meaning that the project has been approved for promotion. Such reports may increase accountability by allowing users to view the status of all projects or update package builds in real-time or near real-time.

As illustrated by the process flow, and unlike conventional systems, accountability of an update package build may be maintained at all times throughout the lifecycle of a project. From when a user initially requests an update package build all the way through launch in a production environment, the code relating to an update package build may be automatically passed between the various processes and steps, thereby avoiding potential human error. Additionally, various checks may be in place to ensure that appropriate people are involved in the various steps of the promotion and deployment lifecycle. For example, approval from a specific manager may be required for promoting an update package build from a development environment to a prototype environment while approval from a different manager may be required before promoting an update package build from a prototype environment to a production environment. Additionally, initiation by a CNC administrator may be required before the update package build may be compiled or launched according to the promotion. Further, embodiments may include reporting systems that provide dashboards (e.g., FIG. 6) or reports (e.g., FIG. 7) to allow for real-time or near real-time status monitoring. While process flow 100 shows step 135 after the update package build has been launched, reporting systems may show the status of projects at any stage of the lifecycle. This eliminates the potential for human error in various steps, such as requests received from users getting lost. This also speeds up the process by eliminating delay caused by repetitive human interaction.

Embodiments may simulate the entire project lifecycle in a single system. Such systems avoid human interactions that can cause error and minimize human interactions that can cause delay. In such systems, all interactions may be between users and the system while the system maintains the code to be promoted. Of course, embodiments may be useful for streamlining only a portion of the lifecycle of a project promotion. For example, in some embodiments, a system may already have package build projects stored in a JDE table. In such embodiments, the system may be useful for allowing users to request promotion of a package build project, acquiring manager approval of the package build project, receiving CNC administrator initiation of the package build project, compiling the package build, and deploying the package build in the environment it was promoted to. In still other embodiments fewer steps may be performed or steps in addition to those disclosed herein may be performed.

While the process flow 100 describes an exemplary embodiment's handling of a single update package build, embodiments may simultaneously perform any of the described steps for plural projects. For example, a developer may at one time request promotion of several separate packages into a target environment. Likewise, a manager may approve plural requests in a single step and an administrator may imitate plural request in a single step.

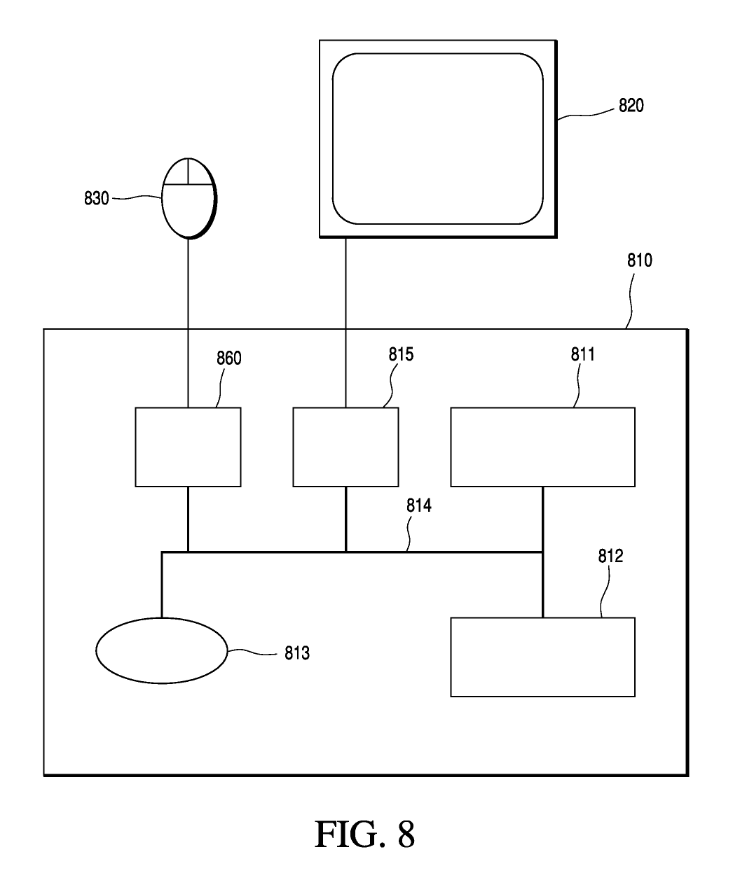

These embodiments may be implemented with software, for example modules executed on computing devices such as computing device 810 of FIG. 8. Of course, modules described herein illustrate various functionalities and do not limit the structure of any embodiments. Rather the functionality of various modules may be divided differently and performed by more or fewer modules according to various design considerations.

Computing device 810 has one or more processing device 811 designed to process instructions, for example computer readable instructions (i.e., code) stored on a storage device 813. By processing instructions, processing device 811 may perform the steps and functions disclosed herein. Storage device 813 may be any type of storage device (e.g., an optical storage device, a magnetic storage device, a solid state storage device, etc.), for example a non-transitory storage device. Alternatively, instructions may be stored in one or more remote storage devices, for example storage devices accessed over a network or the internet. Computing device 810 additionally may have memory 812, an input controller 816, and an output controller 815. A bus 814 may operatively couple components of computing device 810, including processor 811, memory 812, storage device 813, input controller 816, output controller 815, and any other devices (e.g., network controllers, sound controllers, etc.). Output controller 815 may be operatively coupled (e.g., via a wired or wireless connection) to a display device 820 (e.g., a monitor, television, mobile device screen, touch-display, etc.) in such a fashion that output controller 815 can transform the display on display device 820 (e.g., in response to modules executed). Input controller 816 may be operatively coupled (e.g., via a wired or wireless connection) to input device 830 (e.g., mouse, keyboard, touch-pad, scroll-ball, touch-display, etc.) in such a fashion that input can be received from a user.

Of course, FIG. 8 illustrates computing device 810, display device 820, and input device 830 as separate devices for ease of identification only. Computing device 810, display device 820, and input device 830 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 810 may be one or more servers, for example a farm of networked servers, a clustered server environment, or a cloud services running on remote computing devices.

While embodiments disclosed herein generally discuss promotion of projects, embodiments may also handle demotion of projects in similar fashion. Further, a system that handles promotion and demotion of projects may handle them in the same fashion or may treat them differently (e.g., a system may require manager approval for promotion but not for demotion).

Additionally, embodiments generally refer to projects for promoting and deploying from a development environment to a prototype environment or from a prototype environment to a production environment. Of course, embodiments may alternatively be configured for promotion and demotion to and from any source and target environments.

Embodiments have been disclosed herein. However, various modifications can be made without departing from the scope of the embodiments as defined by the appended claims and legal equivalents.

What is claimed is:

1. A computer-implemented method executed by one or more computing devices for project promotion, package assembly, and build processing in a Configurable Network Computing architecture, the method comprising:
receiving, by at least one of the one or more computing devices, a request for a package build from a user;
storing, by at least one of the one or more computing devices, the received request for the package build in a dataset;
transmitting, by at least one of the one or more computing devices, a request for promotion of the package build in response to storing the received request for the package build;
receiving, by at least one of the one or more computing devices, approval of the request for promotion; and
initiating, by at least one of the one or more computing devices, a promotion and build process.

2. The computer-implemented method of claim 1, further comprising generating a promotion and build report.

3. The computer-implemented method of claim 2, wherein the promotion and build report is an interactive dashboard.

4. The computer-implemented method of claim 1, wherein the request for promotion includes an indication of a source environment and a target environment.

5. The computer-implemented method of claim 1, wherein said step of initiating the promotion and build process includes receiving an initiation command from a Configurable Network Computing administrator.

6. The computer-implemented method of claim 1, wherein the step of initiating the promotion and build request includes receiving an automatically generated initiation command.

7. The computer-implemented method of claim 1, further comprising:
collating plural received requests for package builds, wherein the promotion and build process includes assembling and building the plural received requests for package builds, and wherein the step of receiving approval of the request for promotion includes receiving approval of the plurality of requests for promotion.

8. A system for project promotion, package assembly, and build processing in a Configurable Network Computing architecture comprising:
a memory; and
a processor operatively coupled to the memory, the processor configured to perform the steps of:
receiving a request for a package build from a user;
storing the received request for the package build in a dataset;
transmitting a request for promotion of the package build in response to storing the received request for the package build;
receiving approval of the request for promotion; and
initiating a promotion and build process.

9. The system of claim 8, the processor further configured for generating a promotion and build report.

10. The system of claim 9, wherein the promotion and build report is an interactive dashboard.

11. The system of claim 8, wherein the request for promotion includes an indication of a source environment and a target environment.

12. The system of claim 8, wherein said step of initiating the promotion and build process includes receiving an initiation command from a Configurable Network Computing administrator.

13. The system of claim 8, wherein the step of initiating the promotion and build request includes receiving an automatically generated initiation command.

14. The system of claim 8, the processor further configured for:
collating plural received requests for package builds,
wherein the promotion and build process includes assembling and building the plural received requests for package builds, and
wherein the step of receiving approval of the request for promotion includes receiving approval of the plurality of requests for promotion.

15. A non-transitory computer-readable medium having computer-readable code stored thereon that, when executed by a computing device, performs a method for project promotion, package assembly, and build processing in a Configurable Network Computing architecture, the method comprising:
receiving a request for a package build from a user;
storing the received request for the package build in a dataset;
transmitting a request for promotion of the package build in response to storing the received request for the package build;
receiving approval of the request for promotion; and
initiating a promotion and build process.

16. The computer-readable medium claim 15, the method further comprising generating a promotion and build report.

17. The computer-readable medium of claim 15, wherein the request for promotion includes a source environment and a target environment.

18. The computer-readable medium of claim 15, wherein said step of initiating the promotion and build process includes receiving an initiation command from a Configurable Network Computing administrator.

19. The computer-readable medium of claim 15, wherein the step of initiating the promotion and build request includes receiving an automatically generated initiation command.

20. The computer-readable medium of claim 15, the method further comprising:
collating plural received requests for package builds,
wherein the promotion and build process includes assembling and building the plural received requests for package builds, and
wherein the step of receiving approval of the request for promotion includes receiving approval of the plurality of requests for promotion.
